(19) United States
(12) Patent Application Publication
(10) Pub. No.: US 2003/0126283 A1
(43) Pub. Date: Jul. 3, 2003

(54) Architectural basis for the bridging of SAN and LAN infrastructures

(76) Inventors: Ramkrishna Prakash, Houston, TX (US); David M. Abmayr, Spring, TX (US); Jeffrey H. Hilland, Cypress, TX (US); James Fouts, Bellevue, WA (US); Scott C. Johnson, Round Rock, TX (US); William F. Whiteman, Cypress, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/039,125

(22) Filed: Dec. 31, 2001

(51) Int. Cl. G06F 15/173

(52) U.S. Cl. 709/238

(57) ABSTRACT

A system provides a router node to bridge a LAN and a System Area Network (SAN). The router node distributes LAN traffic across the SAN using a router management agent (RMA) and a filter agent (FA); the RMA includes a session management agent (SMA), a policy management agent (PMA) and a routing agent (RA); the SMA manages connections between remote clients and SAN nodes; the PMA maintains system operation policies; the RA with the FA direct LAN packets to SAN nodes; the FA handles conversion between a SAN protocol and a LAN protocol for packets within the SAN/LAN architecture. The cluster nodes include a node management agent (NMA); the NMA includes an SMA and PMA; these two agents perform the same functions as those in the router node; and a management node sets policies on the router node and includes a monitoring agent to query router node statistics.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The invention relates to architectures that utilize multiple servers connected in server clusters to manage application and data resource requests.

2. Description of the Related Art

The exponential increase in the use of the Internet has caused a substantial increase in the traffic across computer networks. The increased traffic has accelerated the demand for network designs that provide higher throughput. As shown in FIG. 1, one approach to increasing throughput has been to replace powerful stand-alone servers with a network of multiple servers, also known as distributed Internet server arrays (DISAs). In their most simplest form, DISAs utilize a shared transaction architecture such that each server receives an incoming transaction in a round-robin fashion. In a more sophisticated form, DISAs utilize load balancing techniques that incorporate distribution algorithms that are more complex. In any case, load balancing is intended to distribute processing and communications activity among the servers such that no single device is overwhelmed.

Typically, and as shown in FIG. 1, DISAs 410, like local area networks (LANs) 420, and particularly LANs 420 connected to the Internet 430, transmit data using the Transmission Control Protocol/Internet Protocol (TCP/IP), see LAN connections 415 in FIG. 1. The TCP/IP protocol was designed for the sending of data across LAN-type architectures. However, DISAs 410, unlike LANs, contain a limited number of server nodes and are all generally located in very close proximity to one another. As such, DISAs 410 do not face much of the difficulties associated with transactions traveling over LANs 420, and as such, do not need much of the functionality and overhead inherent to the TCP/IP protocol. When DISAs are required to use TCP/IP, for example, and as shown by the solid line connections 415, such DISAs are disadvantaged by having to encapsulate and de-encapsulate data as it is travels within the cluster of servers. In fact, as the industry has provided LAN interconnects significantly larger than 100 Mb, i.e., 1 Gb and larger, both application and data resource servers have spent disproportionate amounts of Central Processing Unit (CPU) time processing TCP/IP communications overhead, and have experienced a negative impact in their price/performance ratio as a result. Therefore, although the use of TCP/IP protocol makes sense for transactions traveling across LANs, its use makes less sense for transactions traveling strictly within a DISA.

### BRIEF SUMMARY OF THE INVENTION

Briefly, an illustrative system provides an architecture and method of using a router node to connect a LAN to a server cluster arranged in a System Area Network (SAN). The router node is capable of distributing the LAN based traffic among the SAN server nodes. The LAN uses a LAN based protocol such as TCP/IP. While the SAN uses a SAN based protocol such as Next Generation I/O (NGIO), Future I/O (FIO) or INFINIBAND. The illustrative system, unlike systems where SANs use a LAN based protocol, is able to achieve greater throughput by eliminating LAN based processing in portions of the system.

To achieve this functionality, the router node and the cluster nodes have agents to control the flow of transactions between the two types of nodes. The router node contains a router management agent and a filter agent. The router management agent contains three additional agents: session management agent, policy management agent and routing agent. The session management agent is responsible for management of the connections between a remote client and a cluster node via a router node. The policy management agent holds and controls the policies under which the system operates. The routing agent works with the filter agent to direct incoming LAN service requests and data to the appropriate cluster node. The filter agent performs address translation to route packets within the SAN cluster and the LAN.

The cluster nodes contain a node management agent. The node management agent contains a session management agent and a policy management agent. These session management agents and policy management agents perform the cluster node portion of the same functionality as their counter parts in the router node. One of the cluster nodes is selected as the management node and sets the policies on the router. The management node also includes an additional agent, the monitoring agent, which enables the management node to query the router node on a variety of statistics.

### BRIEF DESCRIPTION OF THE SEVERAL VIEWS OF THE DRAWINGS

A better understanding of the present invention can be obtained when the following detailed description of the disclosed embodiment is considered in conjunction with the following drawings, in which:

FIG. 1 is a component diagram showing a typical LAN-DISA architecture utilizing a LAN based protocol;

FIG. 2 is a block diagram showing a LAN-SAN architecture where both LAN based and SAN based protocols are used;

FIG. 3 is a component diagram showing a LAN-SAN architecture where both LAN based and SAN based protocols are used;

FIG. 4 is a block diagram showing the LAN-SAN architecture in greater detail including each of the multiple agents utilized in the disclosed embodiments;

FIG. 5 shows the format of the policy table; and FIG. 6 shows the format of the session table.

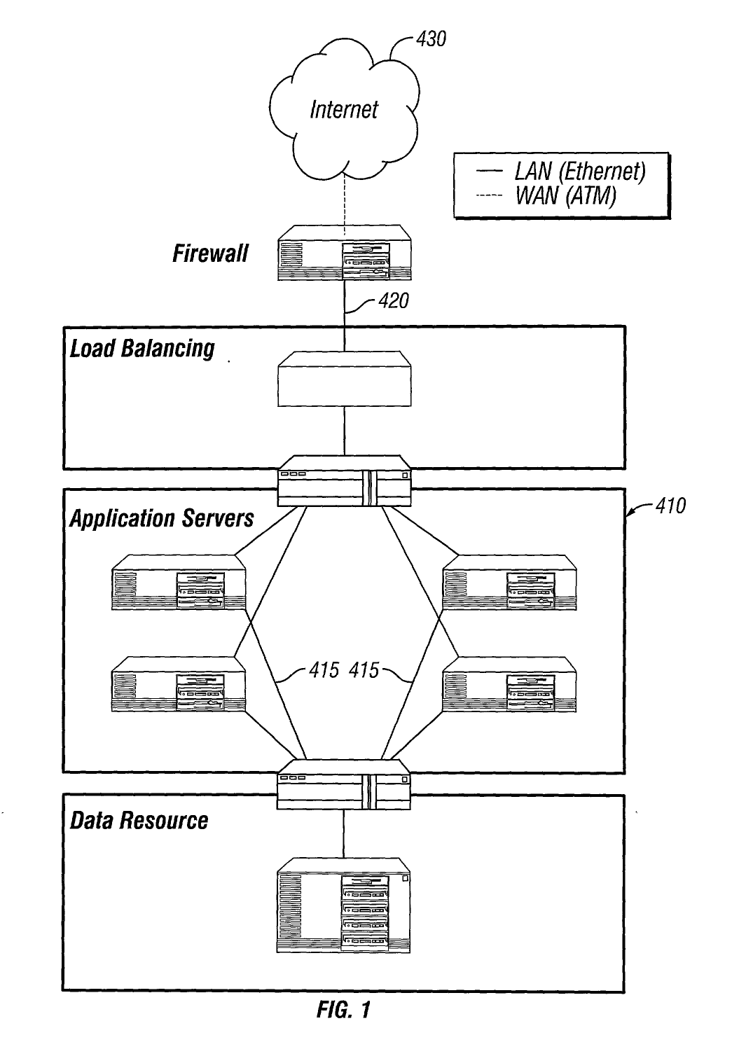

### DETAILED DESCRIPTION OF THE INVENTION

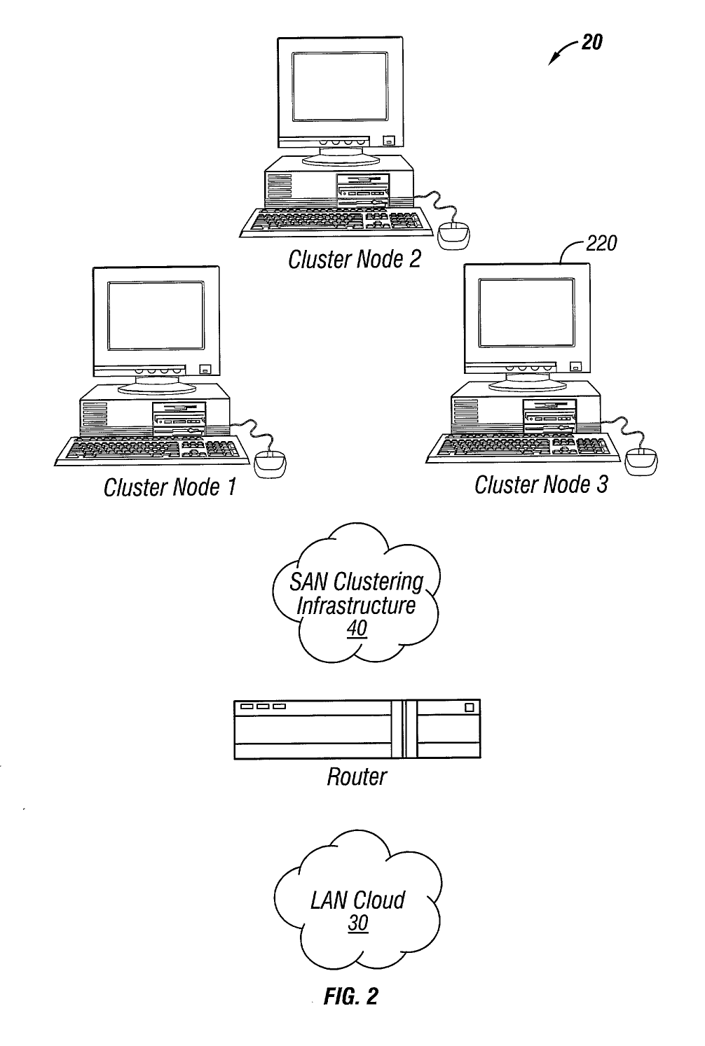

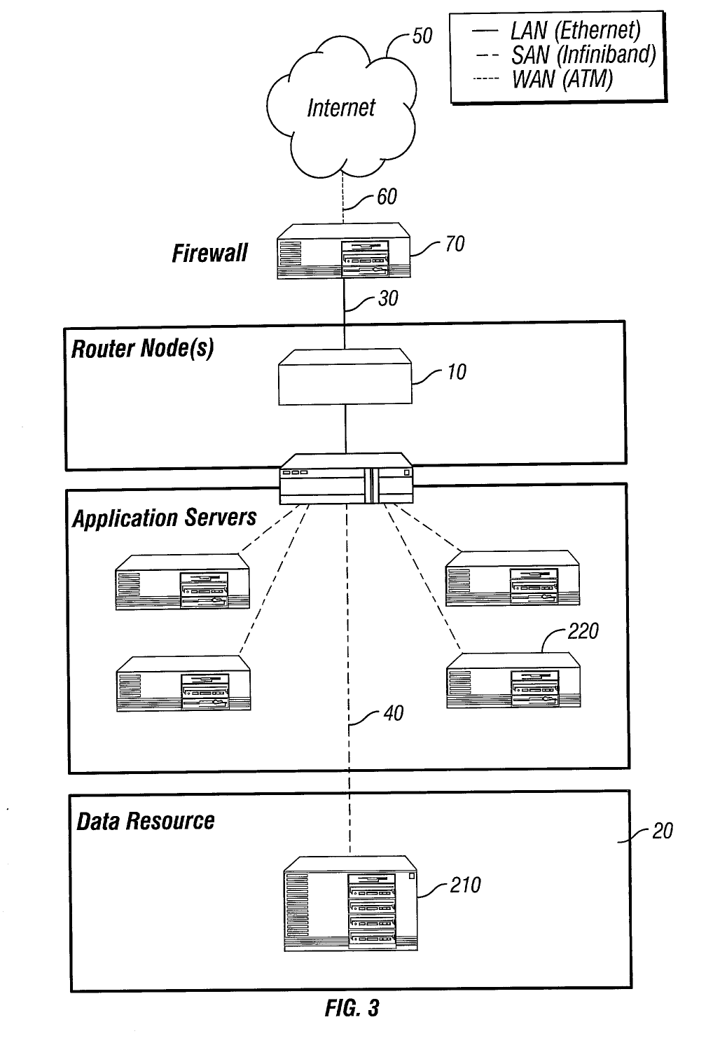

As shown in FIGS. 2 and 3, the disclosed embodiments include all the functionality present in traditional DISA load balancing. However, unlike traditional DISAs that use the same protocols as the LANs they are connected to, i.e., TCP/IP, the disclosed embodiments instead use DISAs which operate under separate System Area Networks SAN based protocols. SAN based protocols are used in SAN-type architectures where cluster nodes are located in close proximity to one another. SAN based protocols provide high speed, low overhead, non-TCP/IP and highly reliable connections. By using such SAN based protocols DISAs are able to take advantage of the processing efficiencies associated with SAN based protocols such as NGIO, FIO and INFINIBAND, all of which are optimally suited for stand alone server clusters or SANs. This dual approach of having separate protocols for connected LANs and SANs allows the burden of the TCP/IP processing to be offloaded from application and data resource servers to router nodes which allows each type of node to concentrate on what it does best. Further, each of the different types of devices can be optimized to best handle the type of work they perform. The disclosed embodiments accommodate higher bandwidth TCP/IP processing than that found in traditional server networks.

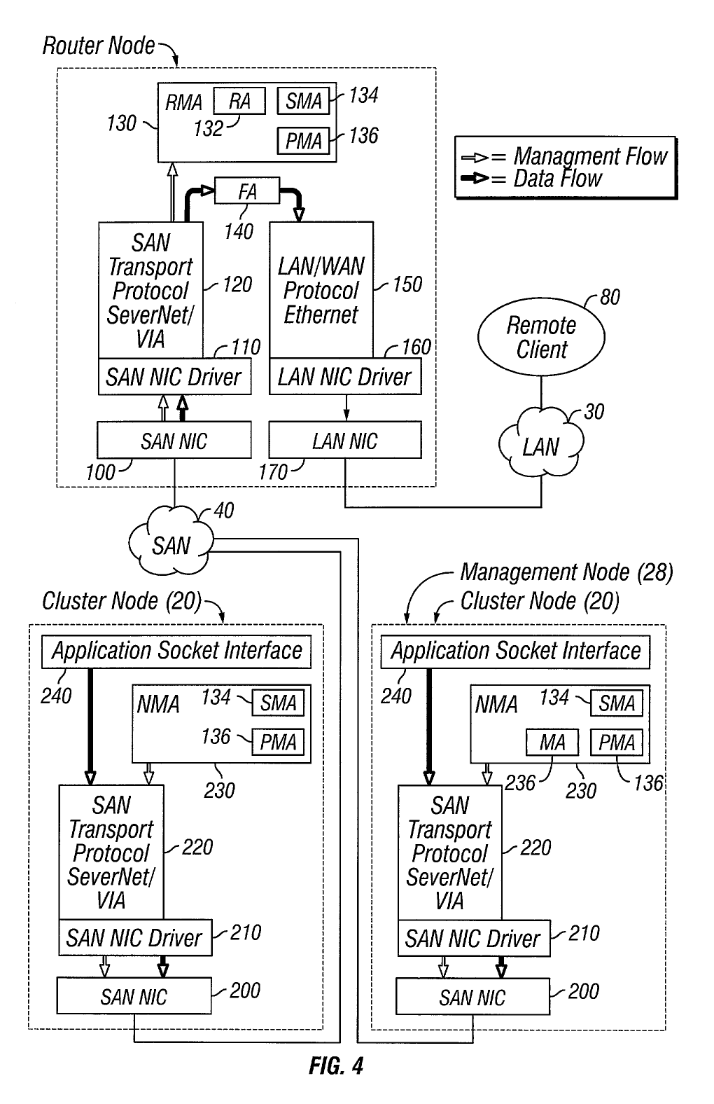

As shown in FIGS. 2 and 4, the Cluster or Server SAN Nodes 20, made up of application server nodes 220 and data resource server nodes 210, are connected to one another via a SAN 40. As shown in FIGS. 2-4, the SAN 40 in turn is connected to a Router Node 10. The Router Node 10 is thereafter connected to the LAN 30. Further, in greater detail as shown in FIGS. 2-4, the Cluster Nodes 20 are attached to one or more Router Nodes 10 via a SAN 40. The Router Node 10 may be thereafter connected to a firewall 70 via a LAN 30, as shown in FIG. 3. Finally, the firewall 70 may be connected to the Internet 50 via a WAN 60 connection, as shown in FIG. 3. Other architectures connecting a SANs and LANs could also be used without departing from the spirit of the invention.

FIG. 4 shows a detailed view of the disclosed embodiment. As shown, the Router Node 10 is connected at one end, to the LAN 30 through a LAN network interface controller (NIC) 170 using a TCP/IP connection, and at the other end, is connected through a SAN NIC 100 to the SAN 40 running a SAN based protocol such as NGIO, FIO or INFINIBAND. The Router Node 10 provides the translation function between the LAN protocol and the SAN protocol and distributes LAN originated communications across the Cluster Nodes 20. Also connected to the SAN 40 are Cluster Nodes 20. As a result, the SAN protocol is used for communication within the cluster and the LAN protocol is used for communication outside the cluster. Although the LAN and SAN protocols mentioned above can operate in conjunction with the disclosed embodiments, other LAN and SAN protocols may also be used without departing from the spirit of the invention.

Although only one Router Node 10 is depicted, it is contemplated that multiple Router Nodes 10 may be used. If multiple Router Nodes 10 are used, they may be so arranged as to perform in a fail-over-type functionality, avoiding a single point of failure. In the fail-over-type functionality, only one Router Node 10 would be functioning at a time. But, if the node was to fail, the next sequential Router Node 10 would take over. Such an arrangement would provide protection against loosing communications for an extended period of time. Alternatively, if multiple Router Nodes 10 are used, they may be arranged such that they each work in parallel. If this parallel functionality were imposed, all of the Router Nodes 10 would be able to function at the same time. This architecture would likely allow greater throughput for the system as a whole since the data processing time to process TCP/IP packets that pass through a Router Node 10 is comparatively slow to the speed at which the requests can be handled once reaching a SAN 40. Thus, in this architecture, enough Router Nodes 10 could be added to the system to balance the rate at which requests are received by the system (LAN activity) and the rate at which the system is able to process them (SAN activity).

As shown in FIG. 4, the Router Node 10 is made up of a Router Management Agent (RMA) 130 and a Filter Agent 140. The RMA 130 interacts with the Node Management Agent (NMA) 230, described below, to implement distribution policies and provide statistical information of traffic flow. The RMA 130 is further comprised of a Policy Management Agent 136 (PMA), Session Management Agent (SMA) 134, and a Routing Agent 132. The PMA 136 is responsible for setting up the service policies and routing policies on the Router Node 10. It is also responsible for configuring the view that the Router Node 10 presents to the outside world. The SMA 134 is responsible for the management of a session. A session is a phase that follows the connection establishment phase where data is transmitted between a Cluster Node 20 and a Remote Client 80 (such as a node in a LAN cluster) via the Router Node 10. Among other functions, the SMA 134 is responsible for the “tearing down” or closing of a session connection between a Cluster Node 20 and a Router Node 10. A Routing Agent 132 is the software component of the RMA 130 responsible for maintaining the Policy Table and routing policies, i.e., the connection information. The Routing Agent 132 works in conjunction with the Filter Agent 140 to direct incoming TCP/IP service requests, as well as data, to the appropriate Cluster Node 20. The Filter Agent 140 is responsible for conversion between the LAN protocol, i.e., TCP/IP, and the SAN protocol and vice-versa.

The Cluster Nodes 20 include a Node Management Agent (NMA). The NMA 230 further comprises a PMA 136, SMA 134 and a Monitoring Agent 236. Here, the PMA 136 and the SMA 134 perform similar functions to the corresponding agents in the Router Node 10, but do so for the Cluster Node 20. One or more of the Cluster Nodes 20 are designated as a Management Node 28 and sets policies on the Router Node 10. This Management Node 28 contains the only Cluster Node 20 with an Monitoring Agent 236. The Monitoring Agent 236, provides the means to obtain various statistics from the Router Node 10. It may work with the PMA 136 to modify routing policy based on statistical information.

Use and Operation of Disclosed Embodiments

Generally

Like typical LAN service requests and grant transactions, the disclosed embodiments interface with the LAN 30 via a socket type interface. A certain number of such sockets are assumed to be ‘hailing ports’ through which client-requests are serviced by the servers. Once the server accepts a client request, it establishes communication with it via a dedicated socket. It is through this dedicated socket that further communications between the server and the client proceeds until one of the two terminates the connection. It should be noted that the operations of the disclosed embodiments are unaffected by whether LAN 30 is a stand alone LAN, or whether LAN 30 is connected with other LANs to form a WAN, i.e. the Internet.

In the disclosed embodiment, the Router Node 10 is responsible for ensuring that the data from a Remote Client 80 connection gets consistently routed to the appropriate Cluster Node 20. The main purpose of Router Node 10, in acting as a bridge between the Remote Client 80 and a Cluster Node 20, is to handle the TCP/IP processing and protocol conversions between the Remote Client 80 and the Cluster Nodes 20. This separation of labor between Router Node 10 and Cluster Node 20 reduces processing overhead and the limitation otherwise associated with Ethernet rates. Furhter, the Router Node can be optimized in such a manner as to process its protocol conversions in the most efficient manner possible. In the same manner Cluster Nodes 20 can be optimized to perform its functions as efficiently as possible. In operation, the Router Node 10 probes the header field of incoming and outgoing packets to establish a unique connection between a remote client and a SAN Cluster Node 20. In the disclosed embodiment the set of Cluster Nodes 20 are viewed by Remote Clients 80 as a single IP address. This architecture allows the addition of one or more Cluster Nodes 20 in a manner that is transparent to the remote world. It is also contemplated that multiple IP addresses could be used to identify the set of Cluster Nodes 20, and which would allow the reservation of a few addresses for dedicated virtual pipes with a negotiated quality of service.

Connection Setup

The Filter Agent 140 in the Router Node 10 performs any address translation between the LAN and SAN protocols. The extent of filtering is based on the underlying transport semantics adopted for SAN infrastructure, i.e., NGIO, FIO, INFINIBAND, etc. The connection between a Remote Client 80 and a Cluster Node 20 is setup via a two phase procedure. The first phase and second phase are called the Connection Establishment Phase and the Session Establishment Phase, respectively.

Connection Establishment Phase

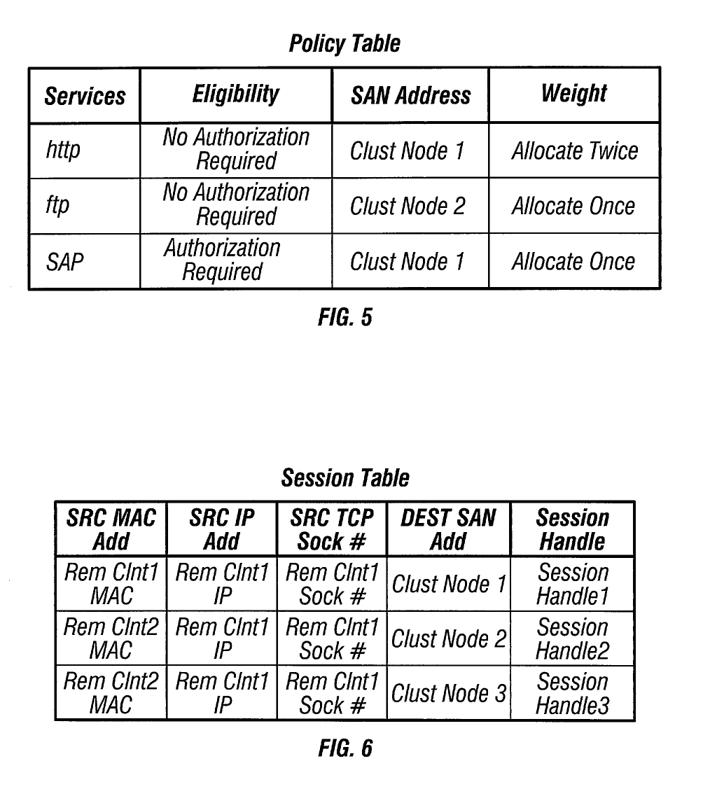

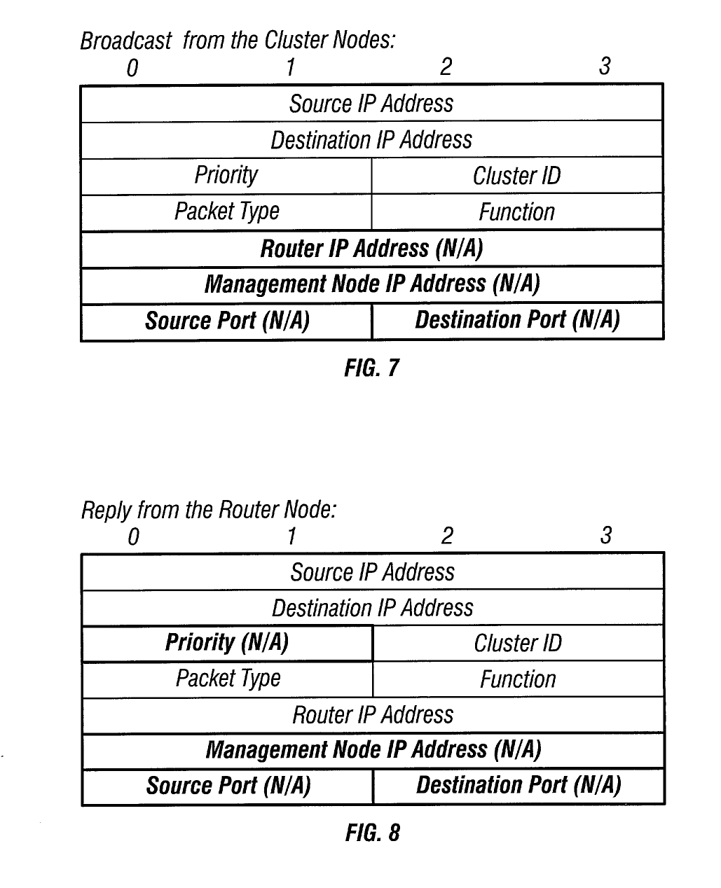

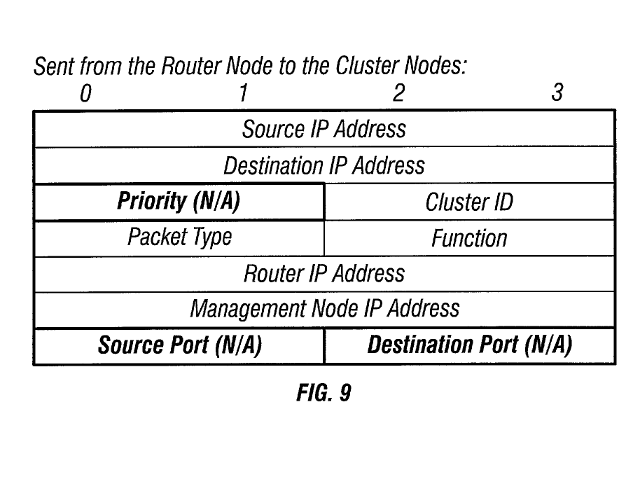

In the Connection Establishment Phase, the Router Node 10 receives a request for connection from a Remote Client 80, and determines, based on connection information in the Policy Table, to which Cluster Node 20 to direct the request. FIG. 5 is an example of a Policy Table which comprises four fields: Service Type, Eligibility, SAN Address and Weight. The Router Node 10 first determines, by probing the incoming TCP/IP packet, the type of service (service request type) for which the Remote Client 80 is requesting a connection. Based on the requested service, the Router Node 10 determines the type of authentication (authentication type) that is required for the requestor. The Eligibility field in the Policy Table encodes the type of authentication required for the service. The procedure to authenticate a requester may range from being a simple domain based verification to those based on encryption standards like Data Encryption Standard (DES), IP Security (IPSEC), or the like. Once the requester has been authenticated the eligible Cluster Nodes 20 capable of servicing the request are determined. Subsequently, one of these eligible Cluster Nodes 20 is selected based on the load balancing policy encoded for the particular service. The Weight field in the Policy Table contains a weighting factor that indicates the proportion of connection requests that can be directed to a particular Cluster Node 20 compared to other Cluster Nodes 20 for a given service. This Weight field is used by the load balancing routine to determine the Cluster Node 20 that would accept this request. Once the Cluster Node 20 has been identified to service the Remote Client 80, the Connection Establishment Phase is complete. The Router Node 10 then communicates with the Cluster Node 20 and completes the establishment of the connection.

Session Establishment Phase

In the Session Establishment Phase, once the connection with the Cluster Node 20 is established, an entry is made in the Session Table for this connection so that subsequent data transfers between the Remote Client 80 and the Cluster Node 20 can be routed correctly. The Session Table, as shown in FIG. 6, containing session information, is stored on the Router Node 10 and comprises five fields which are used by the Router Node 10 to dynamically route incoming and outgoing packets to their appropriate destinations: SRC MAC, SRC IP, SRC TCP, DEST SAN and Session. These five fields are stored because they uniquely qualify (identify) a connection. The first three, SRC MAC, SRC IP, and SRC TCP, handle the LAN side, and the last two, DEST SAN and Session Handle, handle the SAN side. Using this information along with a hashing function or a channel access method (CAM), incoming or outgoing traffic can be sent to their correct destinations. Also, those parts of the Session Table on the Router Node 10 that are associated with the session to a particular Cluster Node 20 are stored on the respective Cluster Node 20.

Management Agents

Two Management Agents, the PMA 136 and the SMA 134, portions of which exist on both the Router Node 10 and each Cluster Node 20, and specifically, within the RMA 130 and NMA 230 respectively, are involved in determining the services provided by the Cluster Nodes 20, and handling the requests from Remote Clients 80. In addition to all the common functions that the PMAs 136 on the Cluster Nodes 20 perform, one or more Cluster Nodes 20 are designated as Monitoring Agents 236 and are responsible for functions that involve cluster wide policies.

Policy Management Agent

The PMAs 136, existing on both the Router Nodes 10 and Cluster Nodes 20, and the RMA 130 and NMA 230 respectively, enable the Cluster Nodes 20 and Router Nodes 10 to inform and validate the services that each other expect to support. When the Cluster Node 20 is enabled, the PMA 136 on the Cluster Nodes' 20 Management Node 28 informs the Router Node 10, via entries in the Policy Table, see FIG. 3, of which services on what Cluster Nodes 20 are going to be supported. In addition, the Management Node 28 identifies the load-balancing policy that the Router Node 10 should implement for the various services. The load-balancing strategy may apply to all of the Cluster Nodes 20, or to a particular subset. The Management Node 28 is also involved in informing the Router Node 10 of any authentication policies associated with the services handled by the Cluster Nodes 20. Such authentication services (authentication types) may be based on service type, Cluster Node 20 or requesting Remote Client 80.

Once the cluster wide policies are set, each Cluster Node 20 informs the Router Node 10 when it can provide the services that it is capable of providing. Any Cluster Node 20 can also remove itself from the Router Nodes' 10 list of possible candidates for a given service. However, prior to refusing to provide a particular service, the Cluster Node 20, should ensure that it does not currently have a session in progress involved with that service. The disassociation from a service by a Cluster Node 20 may happen in a two stage process: the first involving the refusal of any new session, followed by the termination of the current session in a graceful and acceptable manner. Further, any Cluster Node 20 can similarly, and under the same precautions, remove itself as an active Cluster Node 20. This can be done by removing itself from its association with all services or the Cluster Node 20 can request that its entry be removed, i.e., that its row in the Policy Table be deleted.

Session Management Agent

The SMAs, existing on both the Router Nodes 10 and the Cluster Nodes 20, and the RMA 130 and NMA 230 respectively, are responsible for making an entry for each established session between a Remote Client 80 and a Cluster Node 20, and as such, is responsible for management of the connections between a Remote Client 80 and the Cluster Node 20 via Router Node 10. The Session Table on the Router Node 10 encodes the inbound and outbound address translations for a data packet received from or routed to a Remote Client 80. As discussed above, like the Router Node 10, the Cluster Node 20 contains a Session Table with entries associated with the particular Cluster Node 20. In addition, such Session Table entries may include information regarding an operation that may need to be performed on an incoming packet on a particular session, i.e., IPSec.

Filter Agents

The Filter Agent, located on the Router Node 10, performs address translation to route packets within the SAN cluster 20 and the LAN 30. The Filter Agent 140 is separate and apart from the RMA 130.

Monitoring Agents

The Monitoring Agent 236, residing within the NMA 230 solely on the Cluster's Management Node 28, enables Management Node 28 to query the Router Node 10 regarding statistical information. The Monitoring Agent 236 allows the monitoring things like traffic levels, error rates, utilization rates, response times, and like the for the Cluster Node 20 and Router Node 10. Such Monitoring Agents 236 could be queried to determine what was happening at any particular node to see if there is overloading, bottlenecking, or the like, and if so, to modify the PMA 136 instructions or the load balancing policy accordingly to more efficiently process the LAN/SAN processing.

Routing Agents

The Routing Agent 132, located on the Router Node 10, is the software component that is part of the RMA 130 and is responsible for maintaining the Policy Table and policies. The Routing Agent 132 works in conjunction with the Filter Agent 140 to direct incoming TCP/IP service requests and data to the appropriate Cluster Node 20.

FIGS. 7-9 represent the SAN packets that travel between the edge device (Router Node 10) and the Cluster Nodes 20 on the SAN 40. These packets do not appear out on the LAN. The LAN packets as they are received from the LAN can be described in the following short hand format “(MAC(IP(TCP(BSD(User data))))).,” where you have a MAC header with its data, which is, an IP header with its data, which is a TCP header with its data, which is a Berkley Socket Design (BSD) with its data, which is the user data. When a TCP/IP request comes in from the LAN, the information from the request is looked up in the Session Table to find the connection using the source (SRC) MAC, SRC IP, SRC TCP and find the destination (DEST) SAN and Session Handle. Then, the payload data unit (PDU) is taken from the TCP packet and placed in the SAN packet as its PDU, i.e., (BSD(User data)), via a Scatter/Gather (S/G) entry. A S/G list/entry is a way to take data and either scatter the data into separate memory locations or gather it from separate memory locations, depending upon whether one is placing data in or taking data out, respectively. For example, if there were a hundred bytes of data, and the S/G list indicated that 25 bytes were at location A, and 75 bytes were at location B, the first 25 byes of data would end up in A through A+24, and the next seventy-five would be placed starting at location B. The format of the SAN packets that are sent out over the SAN can be either (SAN(User data)) or (SAN(BSD(User data))).

The foregoing disclosure and description of the disclosed embodiment are illustrative and explanatory thereof, and various changes in the agents, nodes, tables, policies, protocols, components, elements, configurations, and connections, as well as in the details of the illustrated architecture and construction and method of operation may be made without departing from the spirit and scope of the invention.

We claim:

1. A server network architecture, the architecture comprising:
a plurality of cluster nodes connected via a SAN-based protocol; and
at least one router node bridging the plurality of cluster nodes to a LAN.

2. The architecture of claim 1, wherein the router node is connected to the LAN via a LAN-based protocol.

3. The architecture of claim 2, wherein the LAN-based protocol is TCP/IP.

4. The architecture of claim 1, wherein the router node is connected to the plurality of cluster nodes via a SAN-based protocol.

5. The architecture of claim 4, wherein the SAN-based protocol is INFNIBAND.

6. The architecture of claim 1, wherein a first router node and a second router node bridge the plurality of cluster nodes to the LAN.

7. The architecture of claim 6, wherein the second router node bridges to the plurality of cluster nodes after the first router node fails-over to the second router node.

8. The architecture of claim 6, wherein the first and second router node bridges to the plurality of cluster nodes in parallel.

9. The architecture of claim 1, wherein the router node comprises a session management agent for maintaining session information for sessions between the router node and a cluster node of the plurality of cluster nodes.

10. The architecture of claim 1, wherein the router node comprises a policy management agent for maintaining connection information and routing policies for the plurality of cluster nodes.

11. The architecture of claim 1, wherein the router node comprises a routing agent for maintaining connection information for the plurality of cluster nodes.

12. The architecture of claim 1, wherein the router node comprises a filter agent for bidirectional conversion between the SAN based protocol and a LAN based protocol.

13. The architecture of claim 1, wherein at least one cluster node comprises a management node for setting routing policies on the router node.

14. The architecture of claim 13, wherein the management node comprises a monitoring agent for obtaining statistics from the router node.

15. The architecture of claim 1, wherein a cluster node of the plurality of cluster nodes comprises a session management agent for holding session information.

16. The architecture of claim 1, wherein a cluster node comprises a policy management agent for maintaining routing policies for the plurality of cluster nodes.

17. A method of bridging a remote LAN client and a SAN cluster node, comprising the steps of:
receiving a LAN protocol communication from the remote LAN client;
transforming the LAN protocol communication into a SAN protocol communication; and
sending the SAN protocol communication to a SAN cluster node.

18. The method of claim 17, further comprising the step of:
establishing a connection between the remote LAN client and the SAN cluster node.

19. The method of claim 17, further comprising the step of:
maintaining statistical information for the SAN cluster node.

20. A method of bridging a SAN cluster node and a remote LAN client, comprising the steps of:
receiving a SAN protocol communication from the SAN cluster node;
transforming the SAN protocol communication into a LAN protocol communication; and
sending the LAN protocol communication to the remote LAN client.

21. The method of claim 20, further comprising the step of:
establishing a connection between the SAN cluster node and the remote LAN client.

22. A router comprising:
a session management agent to maintain session information for sessions with a plurality of cluster nodes over a LAN;
a routing agent to maintain connection information for the plurality of cluster nodes connected via a SAN-based protocol; and
a filter agent to covert between the SAN-based protocol and a LAN-based protocol.

23. The router of claim 22, further comprising:
a policy management agent to maintain routing policies for the plurality of cluster nodes.
